(19) United States
(12) Patent Application Publication
(10) Pub. No.: US 2007/0110267 A1
(43) Pub. Date: May 17, 2007

(54) Mobile speaker

(75) Inventor: Chun I. Liu, Taiyuan City (TW)

Correspondence Address: TROXELL LAW OFFICE PLLC;SUITE 1404, 5205 LEESBURG PIKE, FALLS CHURCH, VA, 22041, US

(73) Assignee: Mei Shan Electronic Co., Ltd.

(21) Appl. No.: 11/274,120

(22) Filed: Nov. 16, 2005

(51) Int. Cl. H04R 1/02; H04R 9/06

(52) U.S. Cl. 381/334; 381/387; 381/394

(57) ABSTRACT

A mobile speaker, which includes a housing, which houses a loudspeaker unit that is formed of a diaphragm and cone assembly and an amplifier, and a flexible electric wire, which is bendable in all directions and kept in the bent shape and has a first end fastened to the housing and electrically connected to the amplifier of the loudspeaker unit and a second end extending out of the housing and terminating in an electric connector connectable to the audio output port of an electronic device.

### BACKGROUND OF THE INVENTION

1. Field of the Invention

The present invention relates to speakers and more particularly, to a simple structure of mobile speaker that can be conveniently carried by the user and that has a flexible electric wire that can be bent into any shape and kept in the bent shape for connection to the audio output port of an electronic device in any desired angle.

2. Description of the Related Art

Following prosperity of the society and improvement of the living standard, stereo equipment has become one of the requisite electric appliances of every family or person. Various mobile speakers have been developed to fit different demands, and have appeared on the market.

Taiwan Utility No. 568485 discloses a speaker assembly, which comprises a hard cabinet, which defines therein a chamber, an amplifier unit packed with a yoke iron, and a buffer unit, which supports the yoke iron of the loudspeaker unit inside the cabinet. The buffer unit has a main plane, an axle hole defined in the main plane for the passing of the loudspeaker unit, and a recessed inside hole, which accommodates the rib or skirt portion of the yoke iron.

A floor speaker or high-raised speaker (see FIG. 1) according to conventional designs commonly has a housing (cabinet) that houses a speaker unit, and an electric cable for connection to computer or stereo equipment. The conventional designs are commonly heavy and expensive, not convenient for carrying by the user or for free connection to computer or stereo equipment in any desired angle.

### SUMMARY OF THE INVENTION

The present invention has been accomplished under the circumstances in view. It is therefore the main objective of the present invention to provide a mobile speaker, which has a simple and compact structure convenient for carrying by the user and, which has a flexible electric wire that can be bent into any shape and kept in the bent shape for connection to the audio output port of an electronic device in any desired angle.

### BRIEF DESCRIPTION OF THE DRAWINGS

FIG. 1 is an elevational view of a speaker according to the prior art.

FIG. 2 is an elevational view of a mobile speaker according to the present invention.

FIG. 3 is a sectional view of a part of the present invention, showing the connection structure between the housing and the flexible electric wire.

FIG. 4 is a schematic drawing showing the electric wire bent into a different shape according to the present invention.

FIG. 5 is a schematic drawing showing an alternate form of the mobile speaker according to the present invention.

FIG. 6 is a sectional view of the loudspeaker unit for the mobile speaker according to the present invention.

FIG. 7 is a schematic drawing showing the. working status of an alternate form of the loudspeaker unit according to the present invention.

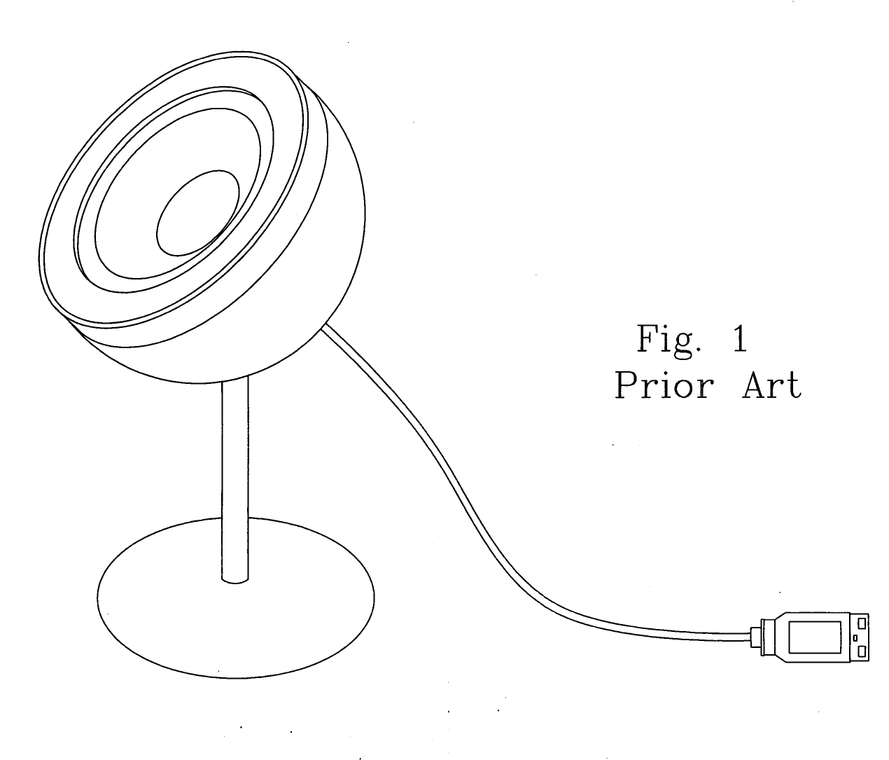

### DETAILED DESCRIPTION OF THE PREFERRED EMBODIMENT

To achieve the foregoing objective, the mobile speaker comprises a housing, which houses a loudspeaker unit, said loudspeaker unit being formed of a diaphragm and cone assembly and an amplifier, and a flexible electric wire, which is bendable in all directions and kept in the bent shape, having a first end fastened to the housing and electrically connected to the amplifier of the loudspeaker unit and a second end extending out of the housing and terminating in an electric connector connectable to the audio output port of an electronic device.

To make it easier to understand the contents of the assembly and other characteristics, a preferred embodiment accompanied with the attached drawings are used for a detailed descriptions as follows:

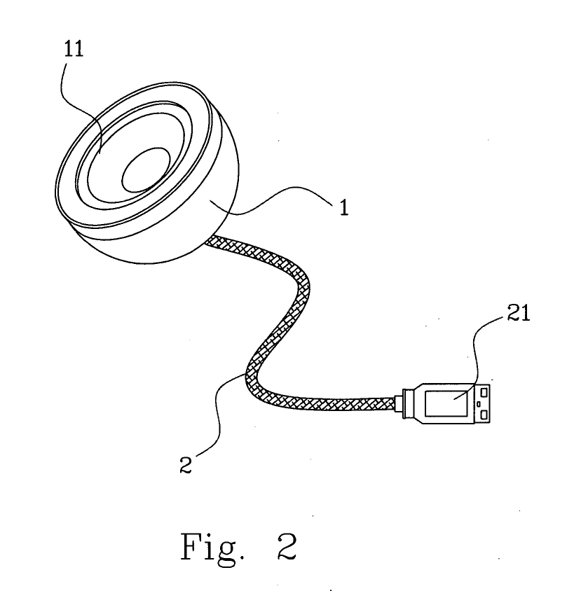

Referring to FIGS. 2˜7, a mobile speaker in accordance with the present invention is shown comprising a housing 1, and a flexible electric wire 2.

The housing 1 is a cabinet that houses a loudspeaker unit 11 formed of a diaphragm and cone assembly and an amplifier 12. The amplifier 12 is adapted for vibrating the diaphragm and cone assembly to produce sound upon connection of electric current.

Further, the housing 1 has a bottom hole 13, and a fitting 3 mounted in the bottom hole 13 for securing the flexible electric wire 2. According to this embodiment, the fitting 3 is a tubular member having a substantially I-shaped profile.

The flexible electric wire 2 can be an armored cable or power cord, or any of a variety of electric wires protected with a telescopic outer tube, having one end affixed to the fitting 3 and electrically connected to the amplifier 12 in the housing 1 and the other end provided with an electric connector 21. The electric connector 21 can be a USB (Universal Serial Bus) connector, or any of a variety of commercial AV (Audio Video) connector.

Referring to FIGS. 2˜4 again, the mobile speaker has a compact size convenient for carrying by the user. The flexible electric wire 2 can be freely bent to any desired direction and kept in the bent shape.

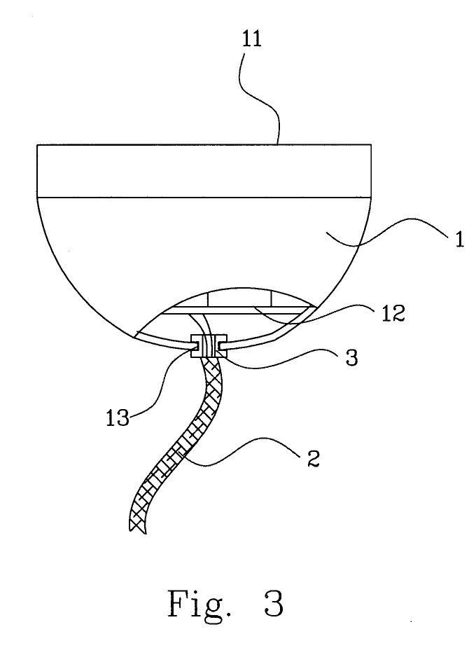

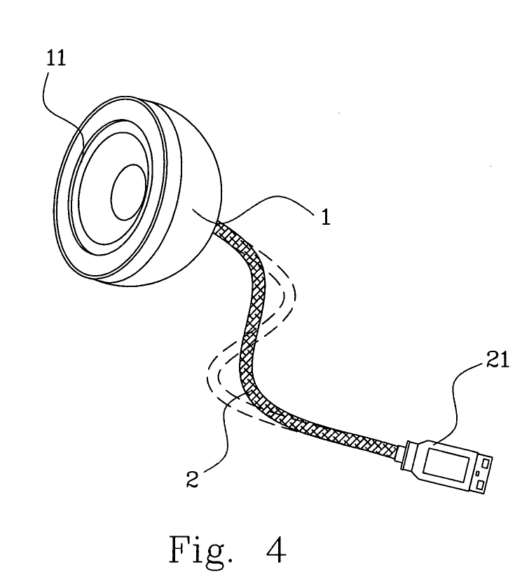

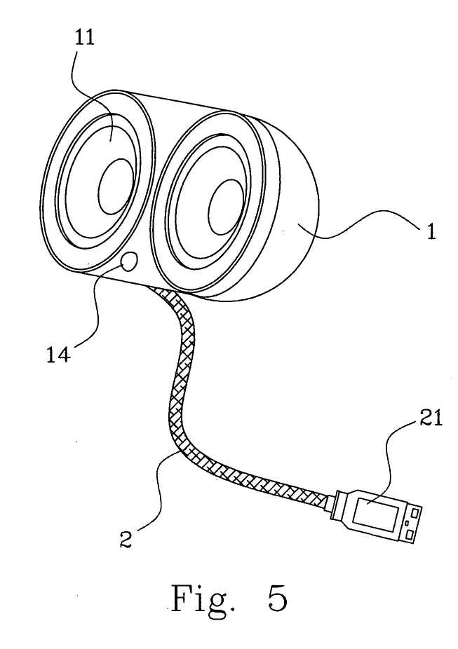

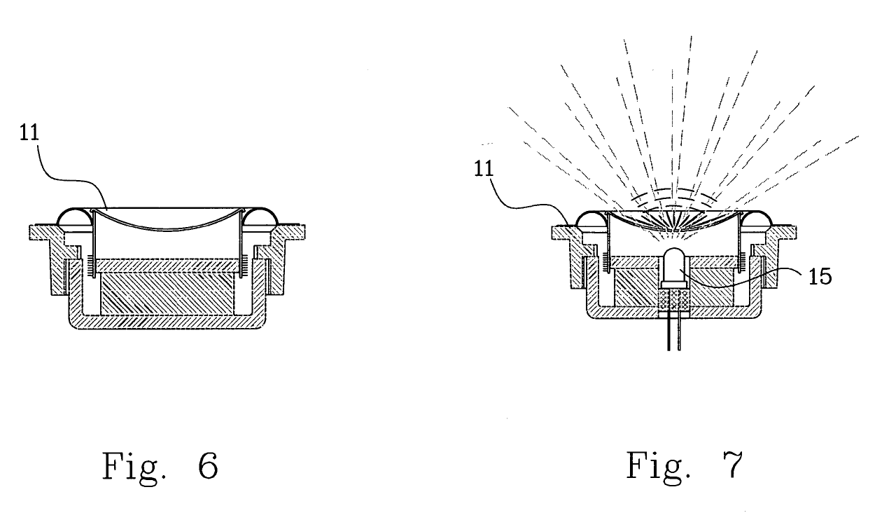

The housing 1 can be made to house one single loudspeaker unit 11 formed of one diaphragm and cone assembly and one amplifier 12 (see FIGS. 2 and 3). Alternatively, the housing 1 can be made to house two loudspeaker units (see FIG. 5).

Referring to FIG. 5 again, an indicator light 14 may be installed in the housing 1 and adapted to give a visual indication signal during working of the speaker.

Referring to FIG. 7, a light source 15 may be installed in the housing 1 and adapted to produce a lighting effect during working of the speaker. The light source 15 can be formed of one single LED (light emitting diode) or a set of LEDs (light emitting diodes).

A prototype of mobile speaker as been constructed with the features of FIGS. 2˜7. The speaker functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mobile speaker comprising a housing, which houses a loudspeaker unit, said loudspeaker unit being formed of a diaphragm and cone assembly and an amplifier; and
a flexible electric wire, said flexible electric wire being bendable in all directions and kept in the bent shape, said flexible electric wire having a first end fastened to said housing and electrically connected to said amplifier of said loudspeaker unit and a second end extending out of said housing and terminating in an electric connector connectable to an audio output port of an electronic device.

2. The mobile speaker as claimed in claim 1, wherein said electric connector is an USB (Universal Serial Bus) connector.

3. The mobile speaker as claimed in claim 1, wherein said housing further houses two loudspeaker unit and indicator light means adapted to produce a visual indication signal upon working of each loudspeaker unit.

4. The mobile speaker as claimed in claim 1, wherein said housing has a bottom hole, and a fitting mounted in said bottom hole for securing said flexible electric wire, said fitting being a tubular member having a substantially I-shaped profile.

5. The mobile speaker as claimed in claim 1, wherein said loudspeaker unit comprises a light source adapted to produce a lighting effect upon working of said loudspeaker unit.
